(19) United States
(12) Patent Application Publication
(10) Pub. No.: US 2010/0236876 A1
(43) Pub. Date: Sep. 23, 2010

(54) BRAKE LINING FOR A SINGLE-DISK OR MULTI-DISK BRAKE

(76) Inventors: Yasar Sarica, Olpe (DE); Jurgen Dreher, Muhlheim-Kahrlich (DE); Andreas Wallner, Wien (AT)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/670,810

(22) PCT Filed: Mar. 18, 2008
(86) PCT No.: PCT/EP08/02167

§ 371 Date: Jan. 26, 2010

(30) Foreign Application Priority Data
Jul. 26, 2007 (DE) 10 2007 035 003.3

(51) Int. Cl. F16D 65/092; F16D 55/36; F16D 65/84; F16D 65/847

(52) U.S. Cl. 188/71.5; 188/251 R

(57) ABSTRACT

Disclosed is a brake lining (3) for a multi-disk brake, comprising a first brake lining (33) with a first carrier plate (6), a first friction lining (4) which is arranged on a front (7) of the first carrier plate (6), a second brake lining (33′) with a second carrier plate (6′) a second friction lining (4′) which is arranged on a front (7′) of the second carrier plate (6′), and at least one connecting means (9) which connects the first carrier plate (6) with the second carrier plate (6′), so that the first and the second friction linings (4,4′) respectively face outwards.

The present invention relates to a brake lining for a multi-disk brake. More specifically, the present invention relates to a brake lining and an intermediate brake lining of a multi-disk brake.

Multi-disk brakes are usually composed of a compression unit which presses a stack consisting of two outer brake linings, at least two floating brake disks and at least one intermediate brake lining together in order to brake. The advantage of a multi-disk brake lies in its increased braking power with only slight additional mechanical effort. The disadvantages are in particular the greater installation height in the axial direction, the lower removal of heat compared to a larger brake disk, the greater travel required of the tensioning device and also the greater friction when not in braking mode.

A further disadvantage of conventional brake linings consists in that sufficient cooling of the brake lining which is clamped between the brake disk and the brake piston (or another compression device) cannot be achieved, as the cooling surface which is available, that is, the edge of the brake lining, is simply too small to allow sufficient removal of heat.

The intermediate brake linings of a multi-disk brake are conventionally constructed of a carrier plate, with a friction lining being applied to both sides of the carrier plate.

This structure has in particular three great disadvantages: an additional mould, an additional production step and thus an additional tool are required for producing the intermediate brake lining, and the outlay for storage is increased by the new brake lining.

According to a first aspect of the present invention, a brake lining is provided for a disk brake. The brake lining according to the invention comprises a carrier plate and a friction lining which is arranged on the carrier plate, with the friction lining having a friction surface. The brake lining is provided with air ducts which extend (essentially) parallel to the friction surface. The friction lining can be additionally cooled from the inside through the air ducts without additional cooling ribs or the like being necessary on the friction lining.

The air ducts are preferably configured as through-holes. This embodiment serves to delimit the present invention unambiguously and unmistakeably from brake linings with cooling ribs.

In a preferred embodiment, the air ducts run essentially radially (in relation to the brake disk). This embodiment has the advantage that the lining shafts are usually open at least upwards and must therefore be changed only slightly in order to use the internally ventilated friction lining according to the invention.

In a further preferred embodiment, the air ducts run essentially tangentially (in relation to the brake disk). This embodiment has the advantage that the direction of the air flow through the air duct can be selected depending on the installation direction of the brake calliper in such a manner that the said air duct is matched to the flow conditions at the site of the brake.

The air ducts advantageously run essentially parallel to the friction direction of the friction lining. In this embodiment, they run in a (circular) arc-shaped manner about the axis of the brake disk to be braked.

In a further embodiment, air ducts are melted to a mesh and form a cavity which is for example pervaded by webs.

In a further embodiment, the brake lining is provided on both sides of the carrier plate with a friction lining. This means that just one centre brake lining of a multi-disk brake can be provided.

In a further embodiment of the present invention, air ducts are arranged in the carrier plate. This means that stability requirements of the brake lining can easily be met, as the required strengths of the carrier plate can be ensured even with air ducts by corresponding choice of materials.

In one embodiment of the present invention, the carrier plate has a two-part configuration. The carrier plate can for example be composed of two halves, between which the air ducts are composed of corresponding depressions in the sides of the carrier plate halves which face each other. The two halves can be held together by clips, rivets, screw-fastenings, soldering, welding or the like. One embodiment of an intermediate disk brake lining, which is described in more detail below, is produced depending on the strength of the carrier plates and whether a friction lining is arranged on both sides of the carrier plates (or carrier plate halves).

In another embodiment of the present invention, air ducts are arranged in the friction lining. This means that the air ducts can simply be formed in the friction lining during manufacture of the latter. This can be achieved for example by conical (polished or otherwise anti-stick) spines, which are included in the mould during moulding of the friction/brake lining and pulled out again after moulding. It is likewise possible to introduce the air ducts gradually into the friction lining by drilling (preferably with a non-metallic drilling method such as water jet drilling or laser drilling).

In a further embodiment of the present invention, air ducts are arranged between the friction lining and the carrier plate. This embodiment allows simple production of the air ducts, as the ducts can simply be configured as depressions in the carrier plate or friction lining before these parts are joined together. This embodiment however requires some effort when connecting the friction lining to the carrier plate in order to ensure that the friction lining cannot detach from the carrier plate during operation.

The air ducts preferably run along a spiral line about the axis of the brake disk(s). This means that any air flow which is produced by the brake disk can be better utilized to cool the brake lining.

The brake lining is preferably provided with at least one holding-down spring which engages in the air ducts (or is clamped to them) and is thus fixed to the brake lining.

According to a further aspect of the present invention, an (intermediate) brake lining is provided for a multi-disk brake. The intermediate (brake) lining according to the invention comprises a first brake lining and a second brake lining and at least one connecting means. The first brake lining has a first carrier plate and a first friction lining which is arranged on a front of the first carrier plate. The second brake lining has a second carrier plate and a second friction lining which is arranged on a front of the second carrier plate. The at least one connecting means connects the first carrier plate to the second carrier plate so that the first and second friction linings each face outwards. The first and second brake linings are connected in such a manner that the rear sides of the carrier plates face each other.

According to a first exemplary embodiment of the present invention, the connecting means comprises at least one clip, which grips around the carrier plates. A clip connection means that the present invention can where appropriate be composed of two single-disk brake linings.

The carrier plates are further preferably provided in each case with cut-outs or depressions into which the connecting means engages or into which the connecting means is sunk. These depressions or cut-outs mean that clips can for example be fixed better and more easily to the carrier plates. The depressions mean that the connecting means can be sunk into the intermediate brake lining in such a manner that the connecting means does not project beyond the outer contour of the intermediate brake lining (for example seen in the axial direction of the brake disk). The depressions mean that the connecting means can be sunk into the first and/or second carrier plates in such a manner that the connecting means does not project or stand out beyond the front of the first and/or second carrier plates (for example in the direction of the first and/or second friction lining). It is also provided for the cut-out to be configured in such a manner that for example a clip which holds the carrier plates together cannot slip off laterally from the carrier plates.

In a further embodiment of the intermediate brake lining, an insulating element is arranged between the first and second carrier plates. The insulating element can for example be used to damp noise cause by friction between the first and second carrier plates. Thermal insulation appears less preferred at this point (when an essentially symmetrical intermediate brake lining is used), as the heat production is likewise (essentially) symmetrical and there is therefore essentially no heat transfer between the first and second brake linings of the intermediate brake lining.

This does not necessarily apply to non-symmetrical intermediate brake linings.

In a further embodiment of the present invention, the (at least one) connecting means comprises at least one projection which is formed on the first and/or second carrier plate.

In an advantageous embodiment, at least one clip is integrally formed on the first and/or second carrier plate. This embodiment relates to an intermediate brake lining in which the connecting means is formed integrally from the material of at least one of the carrier plates of the first and/or second brake lining. This clip can for example be formed by (long, thin) tabs, which are bent around the carrier plate of the respective other brake lining after the first and second brake linings are joined together.

The projections can preferably also form a bayonet closure with which the two brake linings of the intermediate brake lining can be connected to each other.

The first and second brake linings are preferably mirror-symmetrical to each other in shape. If the at least one connecting means is likewise mirror-symmetrical, the entire intermediate brake lining can also be mirror-symmetrical. This embodiment is preferably used in multi-disk brakes with non-symmetrical lateral brake linings.

In one embodiment of the intermediate brake lining, the first brake lining and the second brake lining are identical in shape. If identical brake linings can be used for the first and second brake linings, the outlay on production for the intermediate brake lining can be considerably reduced. In this embodiment the intermediate brake lining can have a rotational symmetry of 180°.

In one embodiment, the connecting means comprises at least one adhesive. An adhesive connection means that the production time for an intermediate brake lining can be reduced. As the forces acting on the connection point are rather low (except for the pressure loading and the thermal loading), an inexpensive adhesive can also be used (for the production process).

The first and/or second carrier plate preferably comprises cooling ribs. If the cooling ribs are arranged on the rear side of the first and/or second carrier plate, an internally ventilated intermediate brake lining for a multi-disk brake lining can be formed in a simple manner. This internally ventilated intermediate brake lining, in combination with internally ventilated brake disks, can considerably improve the performance of a multi-disk brake, as no heat buildup can form in the region of the carrier plate, which can lead to overheating and destruction of the intermediate brake lining. The cooling ribs can also be configured as round or rounded cooling ribs, for example as pin-shaped cooling ribs, that is, cooling pins.

This embodiment indicates a cheap and particularly simple possibility of producing an internally ventilated intermediate brake lining for a multi-disk brake.

The first carrier plate preferably comprises first cooling ribs and the second carrier plate preferably comprises second cooling ribs, with the first cooling ribs and the second cooling ribs interlocking at least partially. This structure means that the two brake linings of the intermediate brake lining can be simply fixed to each other in that the cooling ribs can be bent towards each other and thus brought into engagement with each other. In this embodiment, the two carrier or rear plates can be supported on each other with the integrally formed cooling ribs. The cooling ribs are preferably likewise used to reinforce the carrier plates and to distribute pressure in the carrier plates.

In one embodiment of the intermediate brake lining, the first carrier plate, the second carrier plate and/or the connecting means has at least one pressure-distributing structure. This means in particular that the distance between the carrier plates can be increased, which makes it possible for air to pass between the rear sides of the carrier plates, which can have a positive effect on heat removal. The pressure-distributing structure can also be configured as ribs, in particular as cooling ribs.

The connecting means preferably comprises an insulating structure. The insulating structure can for example be configured as an intermediate layer which is provided with tabs which can be bent around the carrier plates. If the material of the intermediate layer is soft enough, the intermediate layer can at least partially decouple the two brake linings of the intermediate brake linings mechanically from each other, as result of which in particular squeaking of the intermediate brake lining can be prevented or at least reduced. The connecting means can be formed from integrally formed elastomer which connects (or adhesively bonds) the two brake linings and at least partially decouples the two brake linings mechanically from each other.

The connecting means preferably comprise screw-fastenings and/or rivets.

The intermediate brake lining preferably comprises at least one sensor. A temperature sensor can in particular detect the temperature at the critical point in a multi-disk brake. The thermal loading is more than twice that of external (lateral) brake linings, as two friction surfaces are present in a small space, and also no heat can be conducted away to the brake calliper via the rear side of the brake lining.

According to another aspect of the present invention, a multi-disk brake lining set is provided. The multi-disk brake lining set comprises two lateral brake linings and at least one intermediate brake lining according to the invention, in one of the above-described embodiments.

The first and/or second brake lining, from which the intermediate brake lining of the multi-disk brake lining set is constructed, is preferably identical to one of the two lateral brake linings of the multi-disk brake lining set. Even more preferably, the first brake lining, the second brake lining and each of the two lateral brake linings are identical. In this embodiment, only one (pressing/sintering/moulding) tool is needed to produce all the brake linings of a multi-disk brake lining set.

One embodiment of the multi-disk brake lining set, having two lateral brakes with in each case one lateral brake lining carrier plate and one friction lining, is characterized in that the first and/or second carrier plate is essentially half as thick as one of the lateral brake lining carrier plates.

According to another aspect of the present invention, a multi-disk brake is provided.

The multi-disk brake according to the invention has at least two coaxially arranged brake disks (of which one is mounted in a floating manner), a brake calliper which comprises the at least two brake disks, and a multi-disk brake lining set as described above.

The invention is explained below using non-restricting exemplary embodiments which are shown in the drawing.

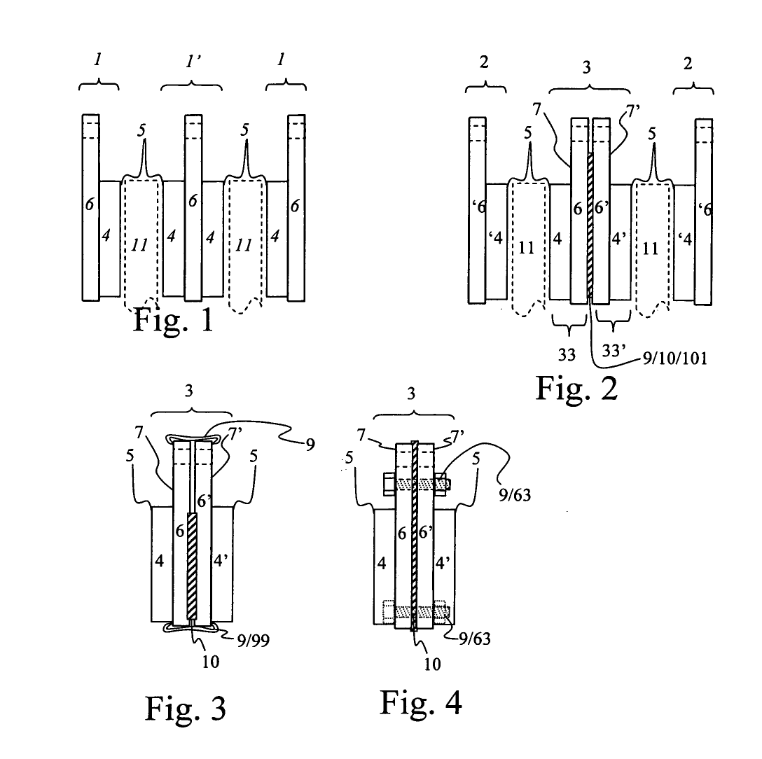

FIG. 1 shows a schematic cross-sectional view of a conventional multi-disk brake.

FIG. 2 shows a schematic cross-sectional view of a multi-disk brake with an intermediate brake lining according to the invention.

FIG. 3 shows a schematic cross-sectional view of another embodiment of an intermediate brake lining according to the invention.

FIG. 4 shows a schematic cross-sectional view of a further embodiment of an intermediate brake lining according to the invention.

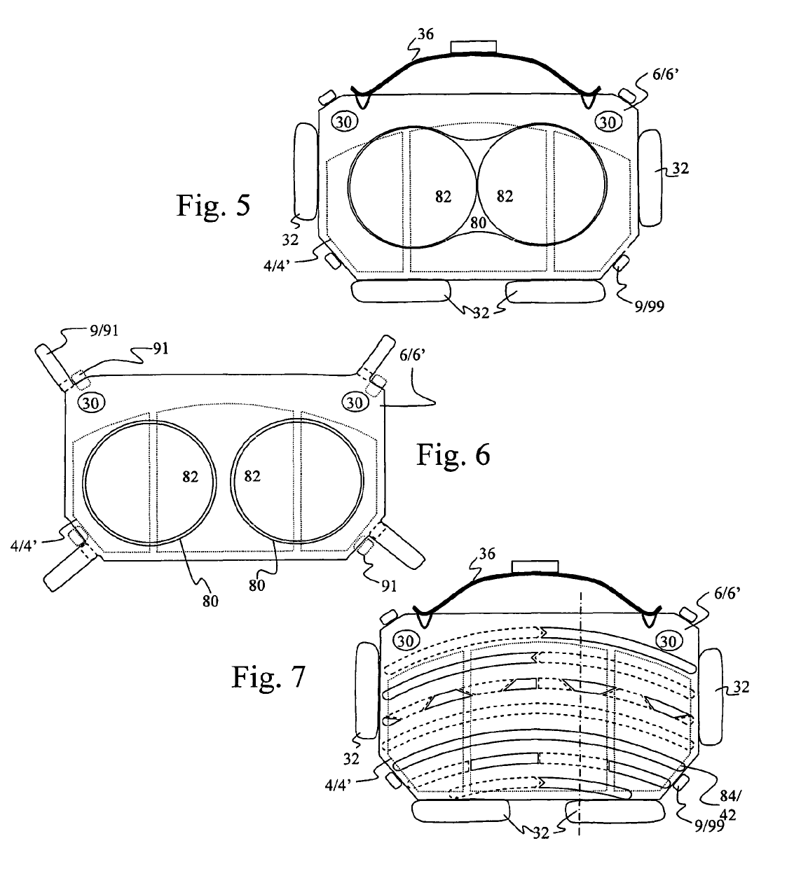

FIGS. 5 to 7 show schematic longitudinal sectional views of further embodiments of intermediate brake linings according to the invention.

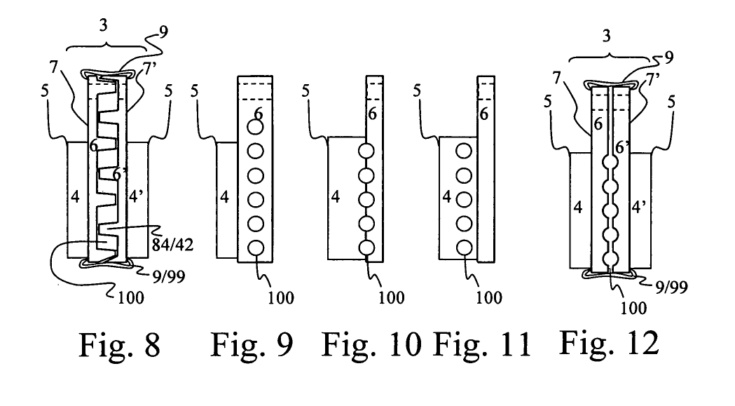

FIGS. 8 to 12 show schematic cross-sectional views of further embodiments of brake linings according to the invention.

The same reference symbols are used both in the figures and in the description to refer to identical or similar objects or elements.

FIG. 1 shows a schematic cross-sectional view of a conventional multi-disk brake. So as not to restrict the clarity of the drawing unnecessarily, the brake calliper and the axle (as well as any floating suspensions) have been omitted in FIGS. 1 and 2. The lateral brake linings 1 are shown as conventional brake linings with in each case one carrier plate ′6 and one friction lining ′4 which is arranged on one side of the carrier plate ′6. The friction surfaces ′5 of the friction linings 1 face the brake disks ′11, which are shown with dashed lines and only partially (cut away in the axial direction). A conventional intermediate brake lining 1′ is arranged between the brake disks ′11. The conventional intermediate brake lining 1′ comprises one carrier plate ′6 on both sides of which in each case one friction lining ′4 is applied, which in each case face the two inner faces of the brake disks 11.

If the stack is compressed externally from the left and right by a brake calliper (not shown), in each case the four friction surfaces 5 come into contact with the two brake disks 11 and brake the brake disks by the friction produced.

FIG. 2 shows a schematic cross-sectional view of a multi-disk brake according to the invention with an intermediate brake lining according to the invention. For the sake of clarity the brake lining according to the invention is referred to with the numeral 2 for the lateral linings and with the numeral 3 for the intermediate lining 3 according to the invention. The lateral brake linings 2 are shown as conventional brake linings with in each case one carrier plate 6 and one friction lining 4 which is arranged on one side of the carrier plate 6. The friction surfaces 5 of the friction linings 1 face brake disks 11, which are shown with dashed lines and only partially (and cut away in the axial direction). An intermediate brake lining 3 according to the invention is arranged between the brake disks 11.

The intermediate brake lining 3 according to the invention comprises a first brake lining 33 with a first carrier plate 6, on the front 7 of which a first friction lining 4 is arranged.

The intermediate brake lining 3 according to the invention likewise comprises a second brake lining 33′ with a second carrier plate 6′, on the front 7′ of which a second friction lining 4′ is arranged.

The first carrier plate 6 is connected to the second carrier plate 6′ by means of at least one connecting means 9, which connects in such a manner that the first and second friction linings 4, 4′ in each case face outwards. The connecting means 9 is configured in FIG. 2 as an adhesive layer 101 which holds the two carrier plates together. The connecting means 9 can form an insulating layer 10 between the carrier plates 6, 6′ depending on the choice of adhesive 101. The insulating layer 10 can decouple the first and second brake linings 33, 33′ thermally and/or mechanically from each other.

An intermediate brake lining 3 is thus formed with two carrier plates 6, 6′, to which a friction lining 4, 4′ is applied in each case, which in each case face the two inner faces of the brake disks 11.

If the stack is compressed externally from the left and right by a brake calliper (not shown), in each case the four friction surfaces 5 of the brake linings 2 and 3 come into contact with the two brake disks 11 and brake the brake disks by the friction produced.

FIG. 3 shows a schematic cross-sectional view of another embodiment of an intermediate brake lining according to the invention. In contrast to the intermediate brake lining 3 of FIG. 2, the intermediate brake lining 3 of FIG. 3 is provided with another connecting means 9. The connecting means 9 is configured as clips 99, which in each case embrace the first and second carrier plates 6, 6′ of the first and second brake linings. An insulating layer 10 is held in corresponding depressions between the carrier plates 6, 6′. The depressions and the clips 99 mean that the insulating layer 10 cannot come out of the intermediate brake lining 3.

The clips 99 can preferably be sunk in corresponding cut-outs (not shown) in the carrier plates 6, 6′ so that they do not project beyond the outer contour of the first or second carrier plate 6, 6′. The clips 99 can preferably be sunk in corresponding cut-outs (not shown) in the carrier plates 6, 6′, with the fronts 7, 7′ of the first or second carrier plate 6, 6′ projecting.

It is likewise provided for projections or depressions to be created on the first or second carrier plate 6, 6′, behind which the clips 99 can grip and which prevent the clips 99 from slipping off outwards easily.

FIG. 4 shows a schematic cross-sectional view of a further embodiment of an intermediate brake lining according to the invention. In contrast to the intermediate brake lining 3 of FIG. 3, the intermediate brake lining 3 of FIG. 3 is provided with another connecting means 9. Screw-fastenings 63 which go through the first and second carrier plates 6, 6′ are used as connecting means 9. The insulating layer 10 is held by projections which extend beyond the edge of the carrier plates 6, 6′. The carrier plates 6, 6′ can also be held in corresponding depressions in the insulating layer 10 so that the insulating layer 10 cannot come out of the intermediate brake lining 3. It is likewise provided for the intermediate layer or insulating layer 10 to be provided with cut-outs through which the screw-fastenings 63 engage.

The screw-fastenings 63 can likewise be sunk in corresponding cut-outs (not shown) in the carrier plates 6, 6′ so that they do not project beyond the fronts 7, 7′ of the first or second carrier plate 6, 6′. It is likewise provided for one of the carrier plates to be provided with (at least) one thread, with which the first and second carrier plate can be connected to each other by means of screw-fastenings 63 (without nuts).

FIGS. 5 to 7 show schematic longitudinal sectional views of further embodiments of intermediate brake linings according to the invention.

FIG. 5 shows a schematic longitudinal sectional view through the intermediate brake lining of FIG. 3, as is used in a lining shaft 32 of a brake calliper. The viewing direction is towards the rear side of one of the brake linings 33, 33′, with the friction lining 4, 4′ which is hidden behind the rear plate 6, 6′ merely being indicated by a dotted line. The intermediate lining is held in the lining shaft by means of a holding-down spring 26. The intermediate brake lining is cut longitudinally in a plane parallel to the plane of the brake disk between the carrier plates. Fixing elements 30 for accessories such as temperature or wear sensors (not shown) are attached in the carrier plate 6, 6′.

Two insulating elements 82 are placed and held in (at least) one corresponding depression 82 in (at least one of the) carrier plates 6, 6′. The depressions and the clips 99 mean that the insulating elements cannot come out of the intermediate brake lining 3.

FIG. 6 shows an embodiment of an intermediate brake lining according to the invention which is similar to that of FIG. 5. In contrast to the embodiment of FIG. 5, the connecting elements 9 (or clips) are formed directly from the rear plate as projections or tabs 91. In order to connect the first and second brake linings, the tabs 91 must in each case be simply bent around the respective other rear plate, as is indicated by the tabs, which are shown with dotted lines, of the other friction lining (cut away and not shown).

FIG. 7 shows an embodiment of an intermediate brake lining according to the invention which is similar to that of FIG. 5. The section and the viewing direction correspond to those of FIG. 5.

In contrast to the previous embodiments, no insulating layer 82 or intermediate layer 10 is provided in the intermediate brake lining. The rear sides of the first and second brake linings 6, 6′ are provided with cooling ribs (which at the same time act as pressure-distributing structures 84 in this case). Different configurations of cooling ribs 42 are shown, which are symmetrical or asymmetrical. The solid lines show cooling ribs or structures which are raised out of the drawing plane. The dashed lines are intended to show cooling ribs 42 which are assigned to the brake lining (not shown and cut away) and which extend from above into the drawing plane.

As in FIG. 5, the first and second brake linings are connected by clips 99 as connecting means 9.

It is likewise provided for the first and second brake linings to be connected by adhesively bonding the cooling ribs 42 to each other or to the carrier plates 6, 6′.

It is likewise provided for the first and second brake linings to be connected to each other by meshing the cooling ribs 42 of the two carrier plates 6, 6′ (for example by bending the cooling ribs 42 with respect to each other).

FIG. 8 shows a possible cross-sectional view of the embodiment of FIG. 7. The section and the viewing direction correspond to those of FIG. 7. The rear side of the first and second brake linings 6, 6′ are provided with cooling ribs 42 (which at the same time act as pressure-distributing structures 84 in this case). The cooling ribs interlock so that air ducts 100 are formed. The configuration of cooling ribs 42 shown corresponds for example to the section shown by the dash-dotted line of FIG. 7. In the configuration shown, the carrier plates 6, 6′ are directed towards each other by the shape of the outer ribs. As the section line in FIG. 7 is made eccentrically, the structure shown can also be composed of identical brake linings. As the figures are shown merely schematically, the curvature of the cooling ribs 42 or air ducts 100 which can be seen in FIG. 7 is not shown for the sake of clarity. The cooling ribs can be configured just as well as studs in order to increase the air-permeability of the air ducts or air chamber.

In contrast to the embodiment shown in FIG. 7, the air ducts can also run completely differently. It is also pointed out that the air ducts in particular do not have to have a constant cross section or a constant cross-sectional area.

FIGS. 9 to 11 show embodiments of an internally ventilated brake lining with air ducts 100. In FIG. 9 the air ducts run through the carrier plate 6. In FIG. 10 the air ducts run between the carrier plate 6 and the friction lining 4. In FIG. 11 the air ducts run through the friction lining 4.

It is to be noted that even combinations of the embodiments shown are possible. It is in particular possible to combine the embodiments of FIGS. 9 and 11 with each other, with air ducts being provided both in the carrier plate and in the friction lining.

FIG. 12 shows an embodiment of a brake lining which uses both a divided carrier plate 6, 6′ and two friction linings 4, 4′. The embodiment shown can be considered an alternative to the embodiments shown in FIGS. 8 and/or 9. In addition, the embodiment of FIG. 12 can be provided with an insulating layer (not shown), which can extend in an essentially planar manner between the carrier plates 6, 6′ (as shown in FIGS. 2 to 4).

It is provided for all combinations of connecting means, carrier plate structures, air ducts and intermediate layers which are not explicitly mentioned to be considered as likewise disclosed.

What is claimed is:

1. Intermediate brake lining for a multi-disk brake, comprising a first brake lining with
a first carrier plate
a first friction lining which is arranged on a front of the first carrier plate,
a second brake lining with
a second carrier plate
a second friction lining which is arranged on a front of the second carrier plate, and
at least one connection between the first carrier plate with and the second carrier plate, so that the first and the second friction linings respectively face outwards.

2. Intermediate brake lining according to claim 1, wherein the connection comprises at least one clip which grips around the carrier plates.

3. Intermediate brake lining according to claim 1, wherein an insulating element is arranged between the first and the second carrier plates.

4. Intermediate brake lining according to claim 2, wherein at least one clip is formed on the first and/or second carrier plate.

5. Intermediate brake lining according to claim 1, wherein the connection comprises at least one projection formed on the first and/or second carrier plate.

6. Intermediate brake lining according to claim 1, wherein the first brake lining and the second brake lining are mirror-symmetrical to each other in shape.

7. Intermediate brake lining according to claim 1, wherein the first brake lining and the second brake lining are identical in shape.

8. Intermediate brake lining according to claim 1, wherein the connection comprises at least one adhesive.

9. Intermediate brake lining according to claim 1, wherein the first and/or second carrier plate comprises cooling ribs.

10. Intermediate brake lining according to claim 1, wherein the first carrier plate, the second carrier plate and/or the connection comprises at least one pressure-distributing structure.

11. Intermediate brake lining according to claim 1, wherein the connection comprises an insulating structure.

12. Intermediate brake lining according to claim 1, wherein the connection comprises screws and/or rivets.

13. Intermediate brake lining according to claim 1, wherein the connection further comprises a holding-down spring.

14. Brake lining for a disk brake, having
a carrier plate and
a friction lining, wherein the friction lining is arranged on the carrier plate
and wherein the friction lining has a friction surface,
wherein the brake lining is provided with air ducts which extend substantially parallel to the friction surface.

15. Brake lining according to claim 14, wherein the air ducts form through-holes.

16. Brake lining according to claim 14, wherein the air ducts extend substantially in radial direction in relation to the brake disk.

17. Brake lining according to claim 14, wherein the air ducts extend substantially in tangential direction in relation to the brake disk.

18. Brake lining according to claim 14, wherein the air ducts extend substantially parallel to the friction direction of the friction lining in relation to the brake disk.

19. Brake lining according to claim 14, wherein the air ducts form a cavity.

20. Brake lining according to claim 14, wherein the brake lining is provided on both sides of the carrier plate with at least one friction lining.

21. Brake lining according to claim 14, wherein air ducts are arranged in the carrier plate.

22. Brake lining according to claim 14, wherein the carrier plate is a two-part carrier plate.

23. Brake lining according to claim 14, wherein air ducts are arranged in the friction lining.

24. Brake lining according to claim 14, wherein air ducts are arranged between the friction lining and the carrier plate.

25. Brake lining according to claim 14, further comprising at least one holding-down spring, which is in engagement with the air ducts.

26. Brake lining according to claim 14, wherein the lining comprises a sensor.

27. (canceled)

28. Multi-disk brake with at least two coaxially arranged brake disks and at least one brake calliper which embraces the brake disks, and a multi-disk brake lining set, characterized in that it is provided with a multi-disk brake lining set according to claim 26.

29. Intermediate brake lining according to claim 1, wherein the lining comprises a sensor.

30. Intermediate brake lining according to claim 1, wherein the intermediate lining is part of a multi-disk brake having at least two coaxially arranged brake disks arranged on opposite sides of the intermediate brake lining and at least one brake caliper which embraces the brake discs.

31. Brake lining according to claim 14, wherein there are at least two of said brake linings included as part of a multi-disk brake having at least two coaxially arranged brake disks arranged on opposite sides of an intermediate brake lining, and with the at lest two brake linings arranged on the outsides of the two brake disks and at least one brake caliper which embraces the brake disks.
